(19) United States
(12) Patent Application Publication
(10) Pub. No.: US 2013/0002842 A1
(43) Pub. Date: Jan. 3, 2013

(54) Systems and Methods for Motion and Distance Measurement in Gastrointestinal Endoscopy

(75) Inventors: Dipankar Das, Los Angeles, CA (US); Marcus O. Filipovich, Venice, CA (US); Jason J. Corso, Buffalo, NY (US); Gregory D. Hager, Baltimore, MD (US)

(73) Assignee: Ikona Medical Corporation, Venice, CA (US)

(21) Appl. No.: 13/457,305

(22) Filed: Apr. 26, 2012

Related U.S. Application Data
(60) Provisional application No. 61/479,316, filed on Apr. 26, 2011.

(51) Int. Cl. H04N 7/18

(52) U.S. Cl. 348/65

(57) ABSTRACT

Systems and methods for extracting and measuring motion from images capture during capsule endoscopy in accordance with embodiments of the invention are disclosed. In one embodiment of the invention, an endoscope system configured to generate a spatial index of images captured along a passageway includes a processor and a camera configured to capture a plurality of images as the camera moves along a passageway, wherein the processor is configured to compare sets of at least two images from the plurality of images, determine motion of the camera along the passageway using the sets of at least two images, determine the distance the camera traveled along the passageway at the point at which an image in each of the sets of at least two images was captured, and generate a spatial index for the plurality of images by associating distances traveled along the passageway with the images.

### CROSS-REFERENCE TO RELATED APPLICATIONS

The current application claims priority to U.S. Provisional Patent Application No. 61/479,316, filed Apr. 26, 2011, the disclosure of which is incorporated herein by reference.

### FEDERAL FUNDING SUPPORT

This invention was made with government support under DK079435 awarded by the National Institutes of Health. The government has certain rights in the invention.

### FIELD OF THE INVENTION

The present invention relates generally to gastrointestinal endoscopy and more specifically to extracting and measuring motion from images captured during capsule endoscopy.

### BACKGROUND

Diseases of the gastrointestinal (GI) tract affect tens of millions of Americans. Commonly encountered intestinal conditions include obscure gastrointestinal bleeding, irritable bowel syndrome, Crohn's disease, celiac disease, intestinal malignancy, and motility disorders. Care for these patients has been hindered due to the inability to non-invasively image the entire intestinal tract, especially the small intestine. For example, 30-50% of occult gastrointestinal bleeding remains unexplained, often due to the inability to obtain direct visualization of the small intestinal mucosal lining. Many patients with abdominal pain and diarrhea are incorrectly diagnosed as having irritable bowel syndrome because a diagnosis of small intestinal Crohn's disease is overlooked. Delay in diagnosis of tumors of the small intestine contributes to the high mortality of these cancers. In addition, an extremely high cost is associated with the differential diagnosis (and treatment) of irritable bowel syndrome and motility disorders.

In the past decade, capsule endoscopy pill-shaped wireless swallow-able imager) has revolutionized the non-invasive visual imaging of the small intestine and more recently the large intestine and esophagus. The capsule endoscope system involves swallowing the pill-shaped imaging device after an overnight fast. The device wirelessly transmits images to an external recorder. Unlike other endoscopic procedures, capsule endoscopy does not require sedation. After swallowing, the patient is allowed to resume normal activity. The capsule is propelled through the GI tract via peristalsis. The patient returns to the physician's office 8 hours after swallowing the capsule, and the data on the recorder is retrieved for analysis. The endoscopy capsule is subsequently excreted with bowel movement and discarded. Unfortunately, due to the large number of images that are generated during capsule endoscopy. User error can occur that may lead to significant morbidity and mortality. One study noted that physicians can miss half of the pathologies in the capsule endoscopy videos they read (see Zheng et al. Detection of Lesions in Capsule Endoscopy: Physician Performance is Disappointing American Journal of Gastroenterology, (online) Jan. 10, 2012).

### SUMMARY OF THE INVENTION

Systems and methods for extracting and measuring motion from images captured during capsule endoscopy in accordance with embodiments of the invention are disclosed. In one embodiment of the invention, an endoscope system configured to generate a spatial index of images captured along a passageway includes a processor, image storage, and a camera configured to capture a plurality of images as the camera moves along a passageway and communicate the plurality of images to the processor, and wherein the image storage is configured to store the plurality of images and the processor is configured to compare sets of at least two images from the plurality of images, determine motion of the camera along the passageway using the sets of at least two images, determine the distance the camera traveled along the passageway at the point at which an image in each of the sets of at least two images was captured, and generate a spatial index for the plurality of images by associating distances traveled along the passageway with images in the plurality of images.

In another embodiment of the invention, an endoscope system includes a capsule endoscope that includes the camera and a computing system containing the processor and the image storage, wherein the capsule endoscope is configured to transmit the captured plurality of images to the computing system.

In an additional embodiment of the invention, an endoscope system further includes a capsule endoscope including the processor, image store and camera.

In yet another additional embodiment of the invention, the camera captures the plurality of images at periodic time intervals.

In still another additional embodiment of the invention, the endoscope is configured to capture color images.

In yet still another additional embodiment of the invention, the processor is further configured to convert color images to grayscale images.

In yet still another additional embodiment of the invention, the endoscope is configured to capture grayscale images.

In yet another embodiment of the invention, the processor is further configured to discard an image when there is an error in receiving the image.

In still another embodiment of the invention, the processor being configured to compare sets of at least two images from the plurality of images includes the processor being configured to detect motion selected from the group consisting of motion in a first axis along the passageway, motion in a second axis perpendicular to the first axis, motion in a third axis perpendicular to the first and second axes, and rotation about the first axis.

In yet still another embodiment of the invention, the processor is configured to detect motion in a first axis along the passageway, motion in a second axis perpendicular to the first axis, motion in a third axis perpendicular to the first and second axes, and rotation about the first axis and the processor is configured to determine motion of the camera along the passageway utilizing the detected motion in the first, second, and third axes, and the detected rotation about the first axis.

In yet another additional embodiment of the invention, the processor being configured to determine motion along the passageway includes the processor being configured to determine the location of a lumen in an image contained in the set of at least two images; and the processor is configured to detect motion detected motion in the first, second, and third axes, and the detected rotation about the first axis utilizing the location of the lumen in the image.

In still another additional embodiment of the invention, the lumen is the darkest area of the image.

In yet still another additional embodiment of the invention, the determination of motion along the gastrointestinal tract further includes down sampling the image.

In yet another embodiment of the invention, the processor is further configured to perform post-processing of the determined motion along the gastrointestinal tract utilizing a non-linear scaling function.

In still another embodiment of the invention, the non-linear scaling function maps determined motion below a predetermined threshold to zero.

In yet still another embodiment of the invention, the non-linear scaling function maps the determined motion to a predetermined value when the determined motion exceeds the predetermined value.

In yet another additional embodiment of the invention, the endoscope system further includes at least one additional camera and the processor is configured to determine motion using images captured multiple cameras.

In still another additional embodiment of the invention, the processor is further configured to measure motion of the walls of the passageway triggered by physiological contractions using the determined motion.

In yet still another additional embodiment of the invention, the passageway is a portion of the gastrointestinal tract and the motion of the walls of the passageway is triggered by peristaltic contractions.

Yet another embodiment of the invention includes an endoscope system configured to measure motion in the walls of a passageway triggered by physiological contractions, including a processor a camera configured to capture a plurality of images as the camera moves along a passageway and communicate the plurality of images to the processor, wherein the processor is configured to compare sets of at least two images from the plurality of images, detect motion of the walls of the passageway using the sets of at least two images and measure the motion of the walls of the passageway triggered by physiological contractions.

In yet another additional embodiment of the invention, the processor being configured to compare sets of at least two images from the plurality of images includes the processor being configured to detect motion selected from the group consisting of motion in a first axis along the passageway, motion in a second axis perpendicular to the first axis, motion in a third axis perpendicular to the first and second axes, and rotation about the first axis.

In still another additional embodiment of the invention, the processor is configured to detect motion in a first axis along the passageway, motion in a second axis perpendicular to the first axis, motion in a third axis perpendicular to the first and second axes, and rotation about the first axis.

In yet still another additional embodiment of the invention, the processor being configured to compare sets of at least two images from the plurality of images includes the processor being configured to determine the location of a lumen in an image contained in the set of at least two images.

In yet another embodiment of the invention, the processor is configured to detect motion of the walls of the passageway relative to the camera using a classifier.

In still another embodiment of the invention, the passageway is a portion of the gastrointestinal tract and the processor is configured to detect motion radially toward a lumen during a peristaltic contraction and detect motion radially outward from the lumen during relaxation following a peristaltic contraction.

In yet still another embodiment of the invention, the processor is configured to display the measurements of the motion of the walls of the passageway triggered by physiological contractions with respect to time via a display device.

In yet another additional embodiment of the invention, the processor is configured to display the measurements of the motion of the walls of the passageway triggered by physiological contractions with respect to distance via a display device.

Still another embodiment of the invention includes generating a spatial index of images captured along a passageway, including comparing sets of at least two images from a plurality of images captured within a passageway using a processor, determining motion of the camera along the passageway using the processor based on the sets of at least two images, determining the distance traveled along the passageway at the point in the passageway at which an image in each of the sets of at least two images was captured, where the distance traveled is determined using the processor based on the determined motion, and generating a spatial index for the plurality of images using the processor by associating distances traveled along the passageway with images in the plurality of images.

Yet another embodiment of the invention includes measuring motion in the walls of a passageway triggered by physiological contractions, including comparing sets of at least two images from a plurality of images captured within a passageway using a processor, detecting motion of the walls of the passageway using the processor based on the sets of at least two images, and measuring of the motion of the walls of the passageway triggered by physiological contractions using the processor.

In yet another additional embodiment of the invention, measuring motion in the walls of a passageway triggered by physiological contractions includes displaying the measurements of the motion of the walls of the passageway over time using the processor and a display device.

In yet another additional embodiment of the invention, measuring motion in the walls of a passageway triggered by physiological contractions includes displaying the measurements of the motion of the walls of the passageway with respect to distance along the passageway using the processor and a display device.

### BRIEF DESCRIPTION OF THE DRAWINGS

FIG. 1 shows a high level flow chart illustrating the generation of a spatial index of images captured within a passageway and/or measurements with respect to time of the motion or motility of the walls of the passageway due to physiological activity by analyzing the motion between images captured in the passageway in accordance with embodiments of the invention.

FIG. 1A shows a flow chart illustrating a process for spatially indexing images captured during capsule endoscopy in accordance with an embodiment of the invention.

FIG. 2 shows a pin-shaped swallow-able capsule endoscope and axes defined relative to the capsule endoscope in accordance with an embodiment of the invention.

FIGS. 3a-3c illustrate sequential images captured by a capsule endoscope and motion vectors determined by comparing the sequential images in accordance with embodiments of the invention.

FIG. 4a illustrates a Z-axis motion translation basis field in accordance with an embodiment of the invention.

FIG. 4b illustrates a Y-axis translation motion basis field in accordance with an embodiment of the invention.

FIG. 4c illustrates a X-axis translation motion basis field in accordance with an embodiment of the invention.

FIG. 4d illustrates Z-axis rotation motion basis field in accordance with an embodiment of the invention.

FIG. 5 illustrates a basis vector field for the Z-axis translation motion basis field that has been modified to account for a lumen-location that is not aligned with the center of the image in accordance with an embodiment of the invention.

FIG. 6 illustrates a non-linear scaling function for post-processing of raw data in accordance with embodiments of the invention.

FIG. 7 illustrates capsule endoscope motion data through the entire small bowel of a patient that has been post-processed in accordance with an embodiment of the invention.

FIG. 8 illustrates the conceptual representation of contractions associated with peristalsis in accordance with an embodiment of the invention.

FIG. 9 illustrates a process for receiving and converting images received from a capsule endoscope in accordance with an embodiment of the invention.

FIG. 10 illustrates a process for comparing sequential image pairs in accordance with an embodiment of the invention.

FIG. 11 illustrates a process for determining the location of the lumen in accordance with an embodiment of the invention.

FIG. 12 illustrates a process for calculating optical flow values in accordance with an embodiment of the invention.

FIG. 13 illustrates a process for the detection of peristaltic contractions in accordance with embodiments of the invention.

FIG. 14 illustrates a process for determining a spatial index for each frame in accordance with an embodiment of the invention.

### DETAILED DESCRIPTION

Turning now to the drawings, systems and methods for analyzing motion between images captured during endoscopy and using the motion information to spatially index the captured images and/or measure motility of a body passageway in accordance with embodiments of the invention are illustrated. In certain embodiments the endoscope comprises a capsule endoscope. As the endoscope travels along a passageway within the body of a subject, the endoscope captures images. These images can be analyzed to detect motion by a processor internal to the endoscope or first communicated out of the endoscope to a computing system containing a processor external to the endoscope, where the images can be analyzed to detect motion. In several embodiments, the motion information is used to determine a spatial index that describes the distances traveled along the passageway at the point at which images were captured. In a number of embodiments, the motion information is used to capture information concerning the motion or motility of the passageway. In a number of embodiments, the motility information can be used to detect motion of the walls of a passageway associated with physiological contractions. In many embodiments, the passageway is part of the gastrointestinal tract (GI tract) and the motility of the passageway is due to peristalsis. A representation of the motion of the walls of gastrointestinal tract due to peristalsis can be referred to as a Peristaltigram™. Although much of the discussion that follows references capsule endoscopes traveling through passageways in the GI tract, as can readily be appreciated the systems and methods described herein can be utilized with a variety of endoscopes in applications involving any of a variety of passageways or ducts within the body of a subject (human or otherwise) including but not limited to the mouth, esophagus, stomach, small intestine, large intestine, bowel, sinus ducts, tear ducts, ureter, fallopian tube, arteries, veins, and/or any duct or passageway that can be imaged.

When a spatial index is generated with respect to images captured by an endoscope system, a clinician can view images based on where the clinician wants to look (i.e. the absolute or relative distance along the passageway) instead of being confined to the temporal order in which the images were taken. For example, in areas where the capsule is stationary, or nearly so, many images may be safely skipped until a new area of a passageway comes into view. Conversely, when the capsule is moving quickly, every image will contain new information. Furthermore, spatial indexing implies that lesions, abnormalities, or other findings can be spatially localized relative to known anatomical structures. This makes it much more likely that they can be reliably identified in subsequent imaging or during an intervention. Finally, spatial indexing makes it possible to compute other properties of the image sequence such as the area of the passageway that was actually viewed during the capsule traversal. In several embodiments, image content control is also utilized as a way of filtering the class of images presented to the user. These capabilities can enhance clinical efficiency while preserving diagnostic sensitivity. In a number of embodiments involving imaging of the small intestine, the captured images can be spatially indexed with respect to the distance traveled along the small intestine to facilitate lesion localization. Spatial indexing can involve generating an initial spatial index (i.e. a sequence that is indexed based upon motion that is apparent from the sequence of images) based upon relative motion and mapping the spatial indexes to the approximate length of the GI tract imaged by the capsule endoscope. In other embodiments, an endoscope is calibrated so that distance measurements (as opposed to relative motion measurements) can be made using the images captured by the endoscope. In several embodiments, an endoscope system is utilized in which the process of spatially indexing images captured during endoscopy is performed as a post capture process on any of a variety of computing devices possessing the capability of performing image processing.

In many embodiments, the process of captured images and detecting motion includes detecting motion of the walls of the passageway due to physiological activity. In several embodiments involving imaging of the GI tract, detected motion in captured images can be utilized to detect motion associated with peristaltic contractions. In certain embodiments, information concerning peristaltic contractions obtained by processing the captured images is visually displayed for review by a gastroenterologist. As noted above, such a visual representation of peristaltic contractions is a form of Peristaltigram™. The detection of motion in images captured by an endoscope as it travels along a passageway, the spatial indexing of the captured images, and the use of the images to detect motility of the passage walls due to physiological activity in accordance with embodiments of the invention is discussed further below. The benefits of these systems and methods can be more readily appreciated by first considering some of the limitations of conventional capsule endoscope systems in the context of applications involving imaging of the GI tract.

### Challenges of Wireless Capsule Endoscopy

As noted above, a common application in which an endoscope is utilized to capture images along a passageway is the use of a capsule endoscope to capture images along a subject's GI tract. While capsule endoscopy has enhanced the ability to diagnose GI tract diseases, it has limitations which impact clinical care of patients. Because the capsule does not proceed down the GI tract at a constant speed, it is often difficult to accurately localize discovered lesions (or other regions of interest) to a specific portion of the small intestine. Another limitation of capsule endoscopy is the large number of images that are captured, often greater than 50,000, resulting in reading times that can exceed one hour and can lead to user error. This has a significant impact on the clinical care of patients.

To increase the likelihood that capsule endoscopy examines a majority of the intestinal surface, multiple images are taken of the same segment of intestine as the capsule moves and rotates through the GI tract with peristalsis. Thus, even at a low frame rate, such as 2 frames per second (fps), there is generally significant overlap between subsequent frames to allow registration of images. Some capsule endoscope techniques have been developed to provide a quick view of the images, such as displaying every “Nth” frame, displaying frames with large amounts of red color (suspected bleeding), changing the speed of image display based on apparent image motion, grouping of similar appearing images, or combining all or part of images, for example, where there is low motion.

Capsule endoscopy is only able to provide a very rough approximation of capsule location within the GI tract based on either the length of time the capsule has been traveling through the GI tract or through an approximate radiofrequency triangulation scheme. However, individual differences in small intestine transit time and variant anatomy have severely limited the usefulness of these approaches. Additionally, patient movement during imaging (i.e. walking around) causes significant error in triangulation results. Anatomical landmarks such as stomach and cecum are also used to aid lesion localization; however, this technique is useful mainly for locations where the lesions are near the beginning or end of the small intestine. Knowledge of whether a particular lesion is reachable by gastroenteroscopy or colonoscopy (for example) is of great value in order for a clinician to decide the best approach to treat the lesion. Furthermore, a more accurate measure of distance between lesions is valuable to aid a physician in determining whether, during subsequent flexible or capsule endoscopy, they have identified all the lesions they previously identified in the earlier capsule endoscopy video. In several embodiments, location information of the capsule helps with time series analysis of diffused pathologies such as (but not limited to) celiac disease and can be used to measure the severity of the localized lesions. Furthermore, with accurate capsule location information and image brightness and appropriate calibration, the shape and size of structural pathologies (e.g. lesions) can be measured. Information concerning the shape and size of structural pathologies can be important in detecting malignant tumors and polyps.

Wireless capsule endoscopy is constrained by several technical barriers. Because the capsule must carry its own power source in a number of embodiments, lighting, imaging, and data transmission must be very power efficient. In particular, images are highly compressed before transmission to the receiver. As a result, images are often of poor quality and low resolution relative to traditional push endoscopy. In many instances, the images are typically taken at a rate of 2 frames per second (fps), and so motion from image to image can be extremely large. At the same time, the imaged structures are highly flexible and animate. The GI tract is in near constant motion due to natural body adjustments and peristalsis. As a result, many of the traditional assumptions made in computational vision, for example scene rigidity, do not hold. Additionally, the images may be obscured by fecal matter, fluids, bubbles, or other matter present in the GI tract.

Although many of the limitations identified above are present in conventional capsule endoscope systems and can be accommodated by spatial indexing processes in accordance with embodiments of the invention, many of these limitations may be overcome in future capsule endoscope systems. Accordingly, processes in accordance with embodiments of the invention can be utilized that can accommodate higher resolution, and/or higher frame rate images. In addition, processes in accordance with embodiments of the invention can utilize additional sources of information such as multiple cameras (e.g. forward and backward facing), and/or information obtained from motion detection sensors. Motion detection sensors include but are not limited to MEMS accelerometers and/or rotation detectors/gyroscopes integrated within a capsule endoscope in accordance with embodiments of the invention. In addition, many capsule endoscope systems may include on board processors and storage capable of storing the captured images and spatially indexing the captured images and/or measuring the motility of the walls of the passageway in which the images were captured. Therefore, the description of processes for spatially indexing images and measuring the motility of walls of a passageway from images captured in accordance with embodiments of the invention should be understood as accommodating the likely advancement of capsule endoscopic systems and the addition of motion data to the information captured by capsule endoscopes.

Processes for Deriving Information from Motion Analysis of Captured Images

Endoscope systems in accordance with embodiments of the invention capture images as the endoscope moves or travels along a passageway. In many embodiments, processes can be utilized to detect motion in the captured images. As can readily be appreciated, in a passageway such as (but not limited to) the GI tract the detected motion can include components associated with the motion of the capsule (in all its degrees of freedom) and motion of the passageway itself due to physiological contractions. Therefore, the detected motion can be used to extract information that can be used to build a spatial index of the captured images. As noted above, a spatial index associates information concerning the distance the camera in the endoscope traveled along the passageway at the point at which an image is captured. The detected motion can also be used to measure the motility of the walls of the passageway. As noted above, in the context of the GI tract such measurements can be visually displayed as a form of Peristaitigram™. Similar visual representations or numerical outputs can be provided in other contexts as appropriate to the requirements of a specific application in accordance with embodiments of the invention. In several embodiments, the endoscope system is configured to generate a spatial index for the captured image and to measure motility of the walls of the passageway. In other embodiments, the endoscope system only uses the motion information to generate a spatial index or only uses the motion information to measure the motility of the walls of the passageway.

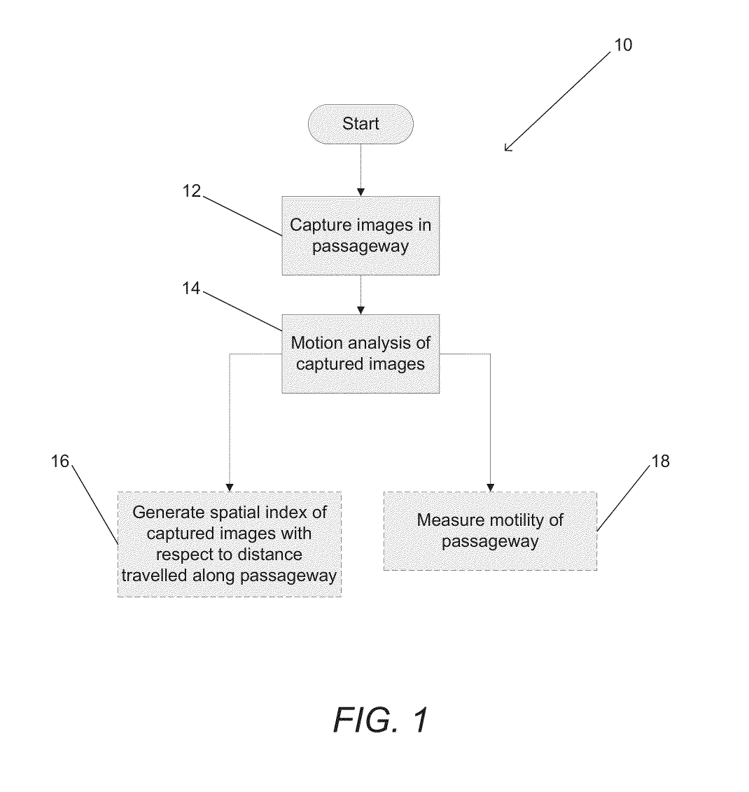

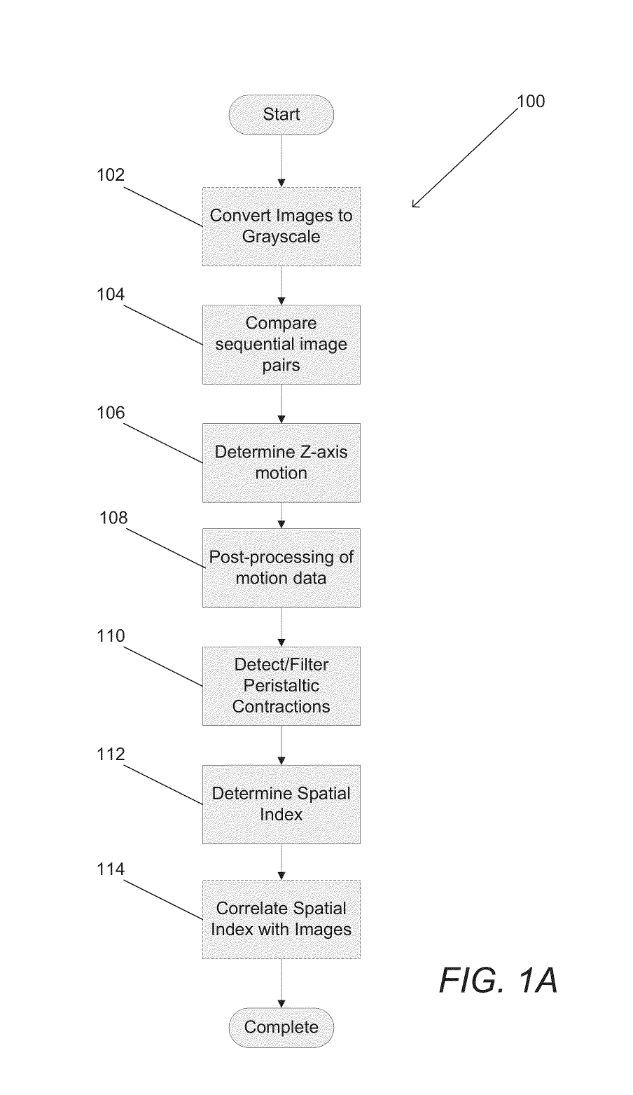

A process for generating a spatial index of images captured in a passageway of a subject and/or to measure motility of the walls of the passageway associated with the physiology of the subject in accordance with embodiments of the invention is illustrated in FIG. 1. The process 10 involves capturing (12) images of the passageway. Sets of two or more images are analyzed (14) to determine the relative motion between images. As is discussed further below, a variety of techniques in accordance with embodiments of the invention can be utilized to isolate motion of the endoscope along the passageway and/or to detect motion of the walls of the passageway relative to the endoscope associated with physiological activity. Based upon the motion detected, a spatial index of the captured images can be determined that associates information concerning the distance traveled along the passageway at the point at which a specific image was captured. As is discussed further below, the process of spatially indexing the captured images can involve filtering detected motion indicative of motility of the passageway. Detection of motility of the walls of the passageway can also be used to measure (18) the motility of the passageway. As is discussed in more detail below, information concerning the motility of a passageway can be an extremely useful diagnostic tool in applications including (but not limited) to inspection of a subject's GI tract.

Although a specific process for generating a spatial index of images captured within a passageway and for measuring motility of the walls of the passageway is described above with respect to FIG. 1, any of a variety of processes can be utilized including processes that only generate a spatial index and processes that only measure the motility of the walls of the passageway in which the images are captured. In addition, processes can utilize information from sources and/or sensors on a capsule endoscope in addition to at least one camera including (but not limited to) accelerometers and gyroscopes. Endoscope systems, methods for generating spatial indexes of images captured within a passageway and methods of measuring motility using images captured within a passageway in accordance with embodiments of the invention are discussed further below with reference to a variety of applications including the imaging of the GI tract to provide a contrast to conventional capsule endoscopy techniques.

### Performing Spatial Indexing of Images Captured During Capsule Endoscopy

Processes for spatially indexing images captured during endoscopy in accordance with embodiments of the invention approximate the physical distance traveled by the capsule endoscope inside a passageway, such as (but not limited to) the GI tract. In many embodiments, the spatial index can then be used to map the sequence of images or a portion of the sequence of images to a section of the GI tract (e.g. between the ileocecal valve and the pyloric valve).

A process for spatial indexing of images captured by an endoscope within a portion of the GI tract in accordance with an embodiment of the invention is illustrated in FIG. 1A. The process 100 includes converting (102) the captured images to grayscale and then comparing (104) images in the sequence to determine the motion of the endoscope between images. The Z-axis motion data (i.e. motion along the gastrointestinal tract and more specifically motion in the direction of the lumen) can then be determined (106) from the motion data obtained by comparing the image pairs. The Z-axis motion information can then be processed (108) to condition the data. Peristaltic contractions can be detected and filtered (110) prior to determining (112) the spatial index of each frame by comparing the cumulative Z-axis motion of each frame in the conditioned sequence to the total Z-axis motion observed in the entire conditioned sequence. In many embodiments, the spatial index is correlated (114) with the images captured by the capsule endoscope.

In many embodiments, a capsule endoscope is utilized to capture the images to which the process illustrated in FIG. 1A is applied in other embodiments, any of a variety of endoscopes can be utilize to capture images within a passageway. Although the process shown in FIG. 1A includes grayscale conversion, many systems in accordance with embodiments of the invention utilize color images for performing spatial indexing. As noted above, the process of comparing images to obtain motion data can incorporate additional information from motion sensors on the capsule endoscope. Although much of the discussion that follows assumes comparison of immediately sequential images, processes in accordance with embodiments of the invention can detect motion between sets of two or images and/or sets of images that are proximate in the sequence and not adjacent. The temporal spacing between compared images is largely dependent upon the frame rate at which images are captured and the requirements of a specific application.

Although a specific process is illustrated in FIG. 1A, any of a variety of processes including but not limited to processes that compare images to determine the motion of a endoscope can be utilized to spatially index images captured during endoscopy of a variety of different types of passageway in accordance with embodiments of the invention. As is discussed further below, instead of filtering information concerning the motility of the passageway processes in accordance with many embodiments of the invention measure the motility of the walls of the passageway as a diagnostic tool. Processes similar to the process illustrated in FIG. 1A can be performed on a processor within a capsule endoscope, remotely on a server, on a personal computer, a tablet computer, a smart phone, and/or any other computing device including a processor capable of analyzing a sequence of images stored in memory. Specific processes that can be utilized in the processing of sequences of images in accordance with embodiments of the invention are discussed below.

### Receiving and Conversion of Captured Images to Grayscale

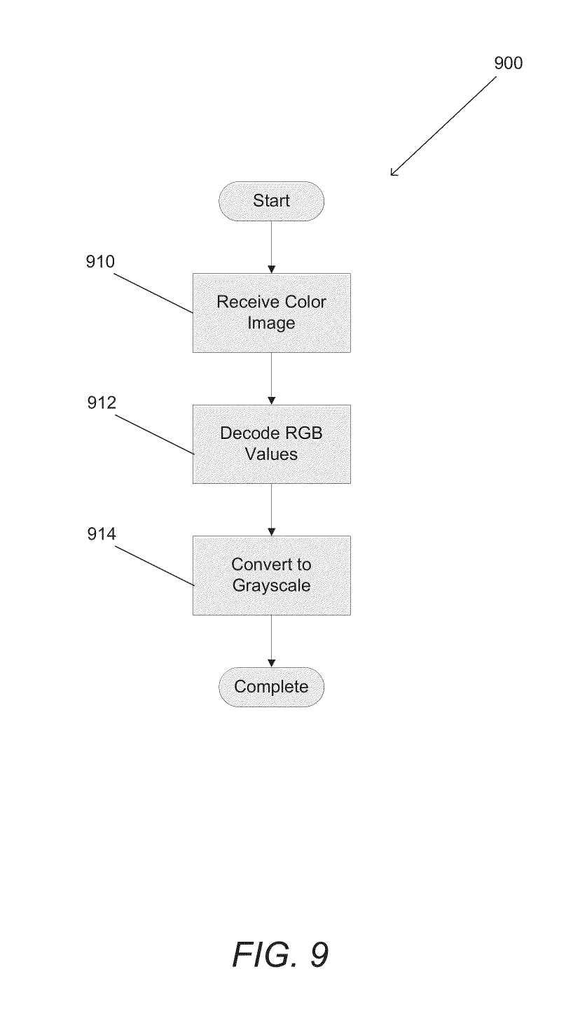

In many embodiments, endoscope systems convert color images received from an endoscope to grayscale images in order to facilitate spatial indexing of the received images. A process for receiving and converting images received from an endoscope in accordance with an embodiment of the invention is illustrated in FIG. 9. The process 900 involves receiving (910) an image from an endoscope, such as (but not limited to) a capsule endoscope. In many embodiments, the image data received (910) from the capsule endoscope has resolution of 256×256 pixels and is in 8 bit JPEG compressed format. When the JPEG image data is decoded (912), each pixel contains red (R), green (G), and blue (B) pixel code-values. In other embodiments, images having any of a variety of image resolutions and encoded in any of a variety of image formats can be processed. In a number of embodiments, the spatial indexing process utilizes grayscale images even though a color image is acquired by the capsule endoscope. For each pixel location, the RGB code-values at that pixel location may be converted (914) into a single grayscale pixel code value Y. Certain embodiments of the present invention may use the following weighted average equation to convert images to grayscale:

Y=0.3*R+0.6*G+0.1*B

Other RGB to grayscale equations can be used in accordance with embodiments of the invention. In several embodiments, the code-values range from 0-255, 0 represents total darkness and 255 represents maximum light-levels. The number of levels for each of the colors utilized by a process in accordance with an embodiment of the invention typically depends upon the capsule endoscope utilized and the requirements of a specific application. Once the spatial index tier each grayscale image is identified, the spatial indexes can be applied to the original color sequence of images.

Although a specific process for receiving and converting color images received from a capsule endoscope is described above, a variety of processes may be utilized, including processes that do not perform grayscale conversion, in accordance with embodiments of the invention. Systems and methods for spatial indexing and motion/distance estimation for capsule endoscopes in accordance with embodiments of the invention are discussed below.

### Comparison of Sequential Image Pairs

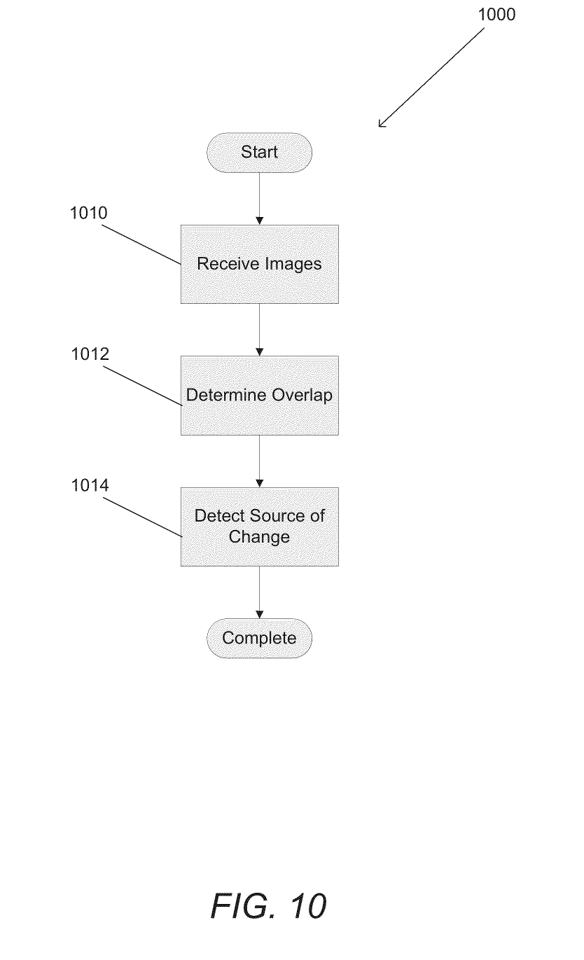

In many embodiments, the location of the endoscope inside a passageway at the time an image is captured is determined by comparing two or more images, which may be, but are not limited to, sequential image pairs. A process for comparing sets of two or more images is illustrated in FIG. 10. The process 1000 includes receiving (1010) images. The images can be received from (but is not limited to) a capsule endoscope. Relative motion between the set of images is detected (1012). The source of motion between the spatially indexed images is detected (1014).

In several embodiments, when transmission errors occur between capsule endoscope and receiver while receiving (1010) images, some systems discard whole image frames, rather than allowing localized distortion or missing image data in a specific area of the corrupt image frame. Motion can be detected (1012) when sufficient frames have sufficient overlap. Some capsule endoscope systems pre-process the images to remove or combine all or part of certain frames or series of frames.

When detecting (1014) the source of change in the sets of images, the three sources of change are assumed to be due to capsule motion, tissue motion and debris motion, in a number of embodiments, the assumption is made that there is no tissue or debris motion and thus all the differences in the sets of images are due to capsule motion, in several embodiments, filters are used to detect (1014) debris or motion due to tissue motion or debris motion. Also, as is discussed below, large motion can be indicative of physiological activity such as (but not limited peristaltic contractions and images captured during such physiological activity can be detected using an appropriate filter and/or classifier. The motion detected (1014) between images captured during physiological activity that causes the passageway to move relative to the endoscope camera can be ignored or otherwise accommodated during the spatial indexing of an image sequence. As is discussed further below, these images can alternatively be used in the measurement of motility of the walls of the passageway as a diagnostic tool.

In several embodiments, the assumption can be made that the Z-axis is aligned with the lumen-location in the direction of forward progress through the GI tract (e.g. there is no camera flipping). Given these assumptions, the process attempts to decompose the capsule motion into the following 4 motion modes:

1) Motion in Z-axis only

2) Motion in Y-axis only

3) Motion in X-axis only

4) Rotation about Z-axis

The calculation of the motion associated with the other motion modes serves to reduce the error in the calculation of the motion in the z-axis.

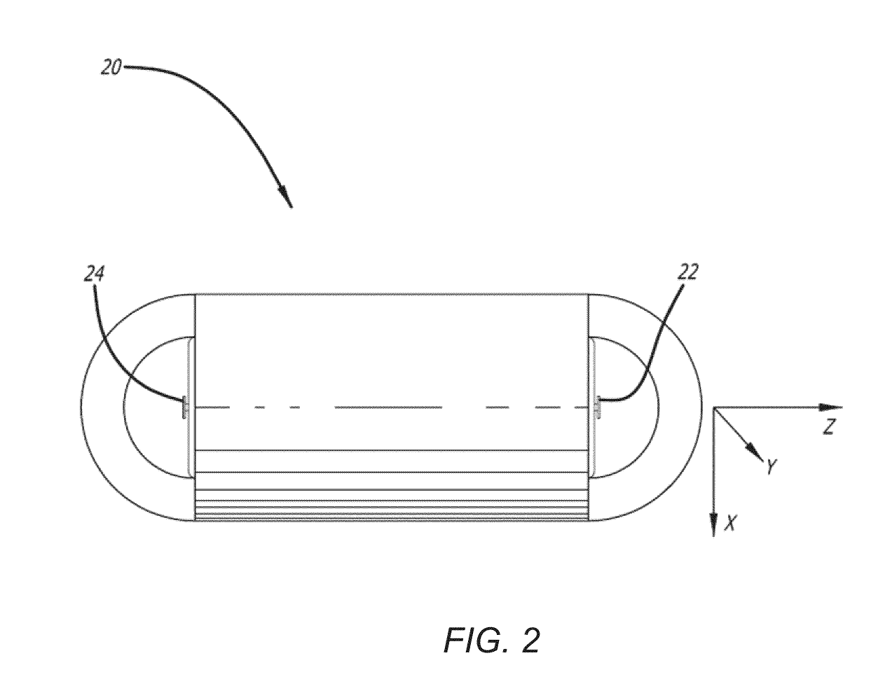

In other embodiments, other motion modes are also detected and/or more or fewer than 4 motion modes are detected. In addition, flips of the endoscope camera can also be accommodated to track the direction of motion. The axis-labeling in relation to a capsule endoscope in accordance with an embodiment of the invention is illustrated in FIG. 2. The axes X, Y, and Z are shown defined relative to a capsule endoscope 20, which in the illustrated embodiment includes both a forward 22 and a backward camera 24.

### Determining Relative Motion Using Optical Flow

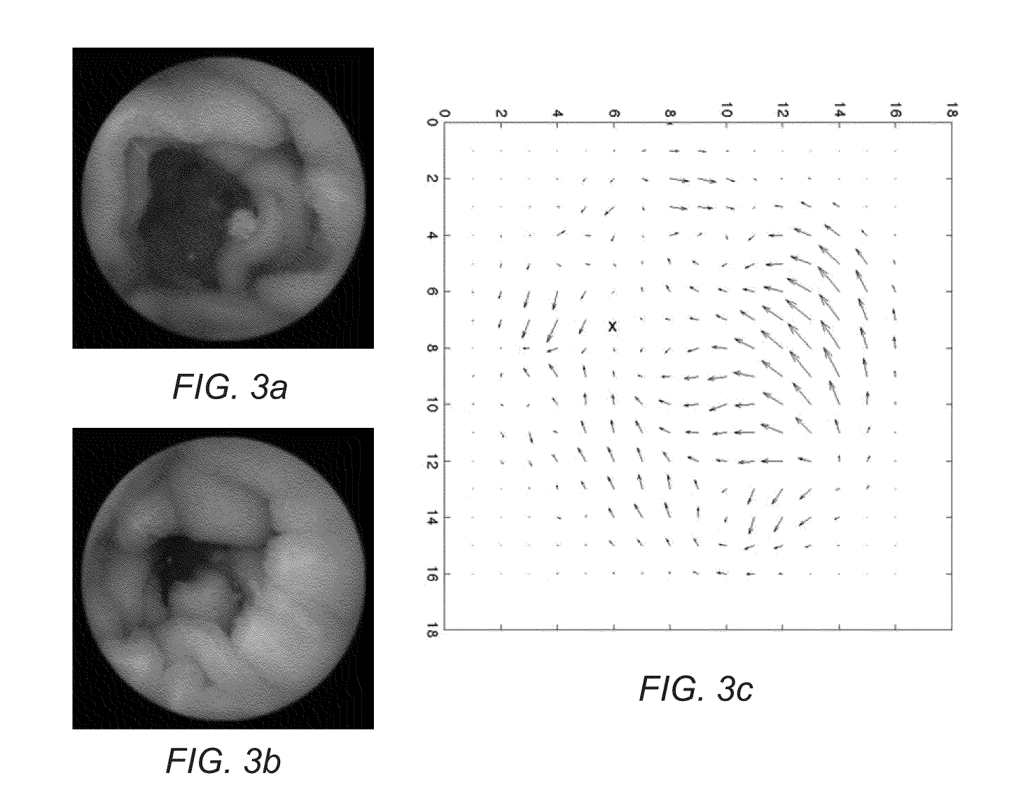

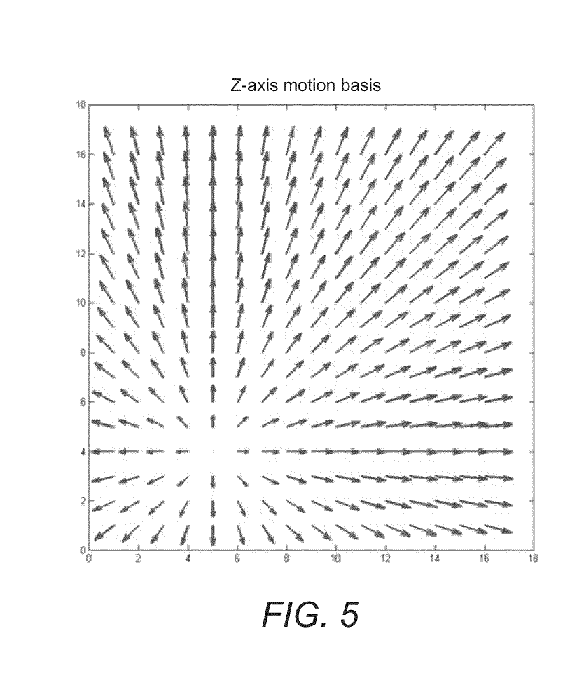

In many embodiments, an optical flow calculation is used to calculate the relative motion between sets of two or more frames. In a number of embodiments, if the motion of all-points is computed, this results in a set of 256×256=65536 motion vectors per sequential pair. A set of two captured images is illustrated in FIGS. 3a and 3b. The corresponding optical flow motion vector field determined in accordance with an embodiment of the invention is illustrated in FIG. 5c. Although much of the discussion that follows relates to the use of optical flow calculations to determine the motion between sequential images, any of a variety of techniques appropriate to a specific application can be utilized to determine the motion between sequential images in accordance with embodiments of the invention.

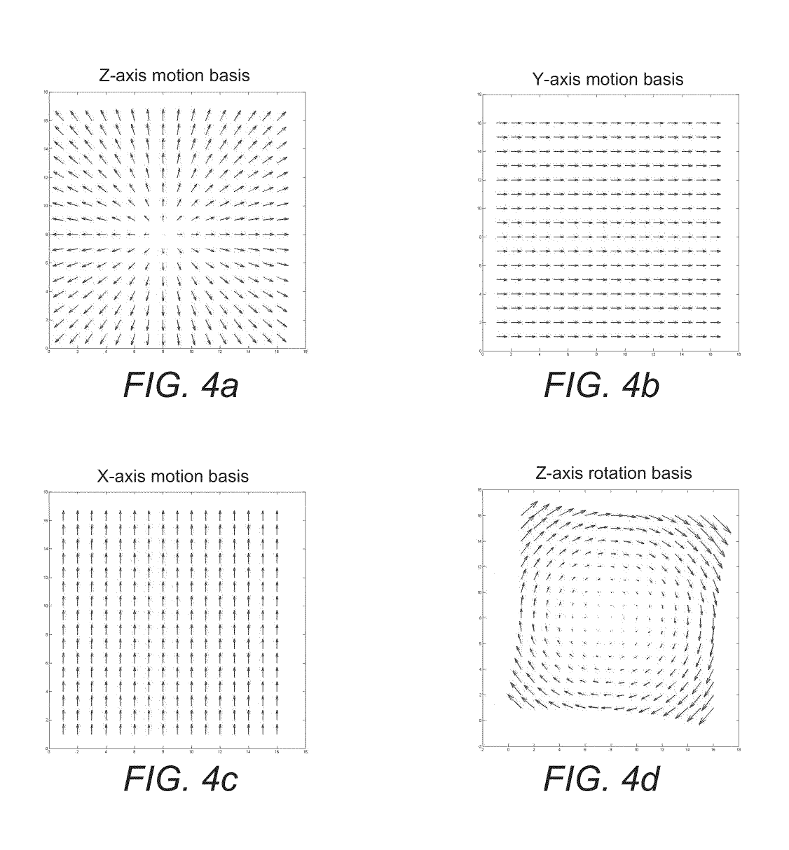

Once the optical flow motion vector field is calculated, the vector field can be decomposed into the four motion modes described above. In several embodiments, the motion vector field is decomposed into the four motion modes using least-squares optimization. The result is a coefficient for each basis motion-vector field. Each basis motion-vector represents one unit of motion in each motion mode. The basis motion-vector fields for the four motion modes are shown in FIGS. 4a-4d. The Z-axis motion basis field 410 is illustrated in FIG. 4a. The Y axis motion basis field 420 is shown in FIG. 4b. The X axis motion basis field 430 is shown in FIG. 4c. The Z-axis rotation basis field 440 is shown in FIG. 4d.

The images of the basis motion-vector fields shown in FIGS. 4a-4d occur when the lumen-location is in the center of the image. Before the coefficients of the basis motion-vector fields are determined, the lumen-location is calculated (see below). The lumen-location is used to modify the basis vector fields, for example, for the Z-axis motion basis field, instead of having the center of expansion equal to the center of the basis vector field (which corresponds to the center of the image), the lumen-location is used as the center of expansion for the basis vector field. The basis vector field fir the Z-axis motion basis field that has been modified to account for a lumen-location that is not aligned with the center of the image in accordance with an embodiment of the invention is shown in FIG. 5.

### Determining the Location of the Lumen

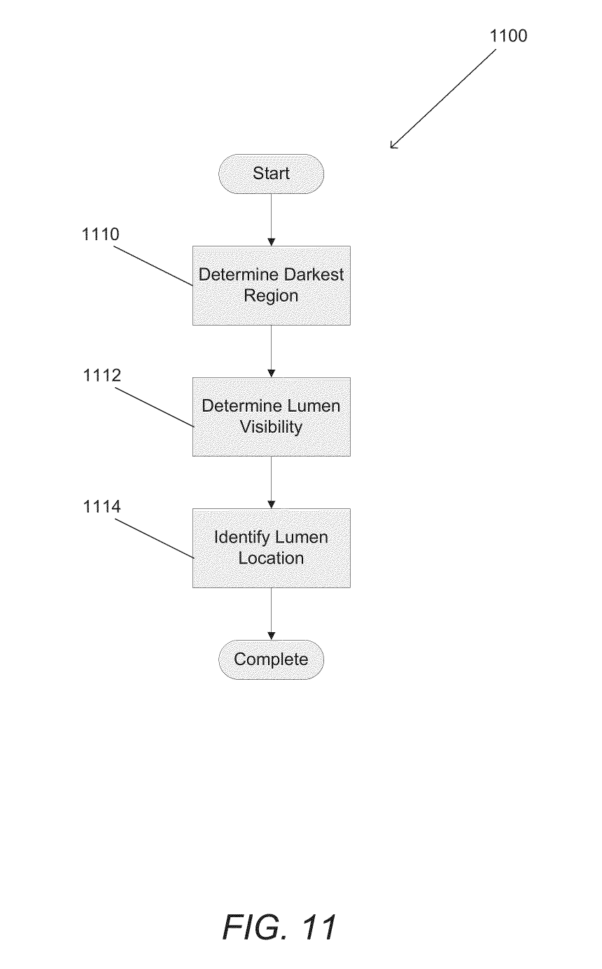

In many embodiments, the orientation of an endoscope is determined using a point of reference. In several embodiments, the orientation of a capsule endoscope may be determined by analyzing the location of the lumen. A process for determining the location of the lumen in accordance with an embodiment of the invention is illustrated in FIG. 11. The process 1100 includes determining (1110) the darkest region visible to the capsule endoscope. The visibility of the lumen is determined (1112) and the location of the lumen is identified (1114).

In a number of embodiments, the location of the lumen is determined (1114) by assuming that the lumen area is the darkest region of the image of the GI tract. Due to capsule endoscope geometry, the lumen will typically be farther away from the camera and light source than the passageway wall, and therefore the lumen areas will reflect less light. Accordingly, the lumen will likely result in darker pixels than the wall. The center of the lumen can then be identified (1114) by locating (1110) the centroid of the darkest region of the image (in the illustrated embodiment the images are of the GI tract). In certain orientations, no lumen will be visible (1112) in the captured image (e.g. when the field of view of the capsule endoscope is completely occupied by the wall). In these cases, the process can identify the absence of a lumen by setting an appropriate pixel threshold for the darkest pixel of the image of the GI tract. In the event that the darkest pixel exceeds the threshold, then the process can determine (1112) that the lumen is not visible in the image. In a number of embodiments the lumen can be located by image segmentation techniques by using color, texture and image intensity values or by identifying the unique features relating to folds or structures in the intestine that point as radial lines towards the centroid of the lumen. In several embodiments, the lumen can be located using specific features of the gastro intestinal tract. In a number of embodiments, the centers of a series of semi-concentric circles or triangles can be used to indicate the center of the lumen in the large intestine even if the lumen is obstructed. In other embodiments involving imaging of any of a variety of passageways, appropriate features and/or techniques to derive the location of the lumen can be utilized. In many embodiments, these techniques are combined.

### Calculating Optical Flow Values and Image Localization

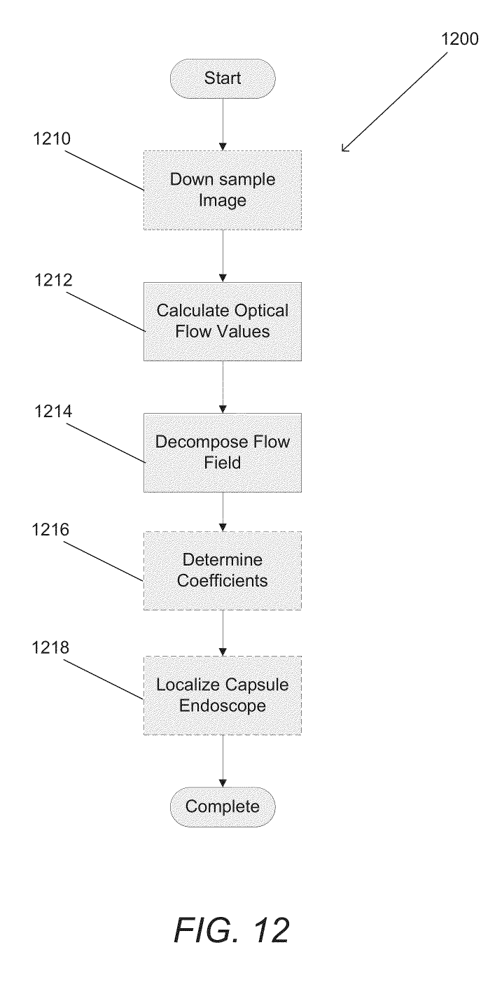

In many embodiments of the invention, the motion of an endoscope is determined by calculating the flow of the endoscope using the images captured by the endoscope. A process for calculating optical flow values in accordance with an embodiment of the invention is illustrated in FIG. 12. The process 1200 includes down sampling (1210) the images in many embodiments of the invention. Optical flow values are calculated (1212) and decomposed (1214) into a flow field. In many embodiments, coefficients are determined (1216) for the flow field. This information is utilized to localize (1218) an endoscope in several embodiments of the invention.

In a number of embodiments, down sampling (1210) the image resolution reduces high-frequency texture and noise components from the images. In several embodiments, the down sampling is performed using a Gaussian down-sampling filter. In a number of embodiments, any down sampling appropriate to a specific application can be utilized in accordance with embodiments of the invention. In several embodiments, calculating (1212) the optical flow values for images is performed utilizing the process described in the paper by Jean-Yves Bouguet entitled “Pyramidal Implementation of the Lucas Kanade Feature Tracker” “, Technical report, Intel Corporation, Research Labs, 1994, the disclosure of which is incorporated by reference herein in its entirety, is utilized to calculate the optical flow values. In other embodiments, any of a variety of processes for determining the motion of the endoscope based upon a comparison of images can be utilized in accordance with embodiments of the invention to calculate (1212) optical flow values. In a number of embodiments, the size of the arrays of optical flow vectors produced by the comparison can be reduced to provide faster processing.

Once the optical flow fields have been obtained, they are decomposed (1214) into the four basis flow fields corresponding to the expected motion modes. As discussed above, there are many degrees of freedom of capsule motion which can be summarized using four typical modes. Assuming a constrained environment for the capsule endoscope, the anticipated motion is along the Z-axis with rotation about the Z-axis, along the X-axis, and along the Y-axis. Using camera parameters including focal length, sensor size, and field of view, and using expected distance and lumen location relative to the camera axes, the four basis flow fields corresponding to motion isolated to each respective motion can be obtained (for examples using a least squares error optimization).

In a number of embodiments, coefficients are determined (1216) using the output of the least squares optimization or another appropriate technique. The coefficients are the four numbers corresponding to the four basis motion vector fields. Each number represents the scaling coefficient of the basis motion vector field that best matches the optical flow motion vector field. So if the basis motion vector field represents 1 unit of motion, and the scaling coefficient provided by the least squares optimization is 5.7, then this means that the optical-flow motion vector fields represents 5.7 units of motion in that particular motion mode. The 1 unit of motion can be defined in terms of an absolute motion. For example, the motion unit can be defined to be equivalent to 1 mm or 1 cm of movement.

In a number of embodiments, a flow field may be represented using a Cartesian coordinate system. For each (x, y) position in the flow field, there are x and y flow values computed by the optical flow calculation explained above. In addition, for each x and y position in the four motion models, there are x and y flow values. Therefore, there are two known values and four unknown values that represent the coefficients of motion for each of the four motion models. These coefficients can be expressed as a linear combination of the basis fields. When only one (x, y) position is considered, the linear combination cannot be determined (1216). When a large number of pixels are considered (e.g. 256×256) then the problem is over-determined and the four unknown coefficients can be determined (1216) using processes including, but not limited to, least squares approximation. In embodiments where the optical flow calculation 1200 produces confidence values, then the determination (1216) of the coefficients can be limited to pixels for which the flow field is determined (1214) with a comparatively high degree of confidence. Reducing the number of values in this way can improve the accuracy of the determined (1216) coefficients by discarding outliers.

In order to localize (1218) the capsule endoscope at the time an image was taken, the coefficient of motion corresponding to the Z-axis-only mode is determined for each pair of frames that are compared. If the coefficient of motion corresponding to the Z-axis-only mode is greater than zero, then this means the capsule endoscope is advancing forward though the passageway. If the coefficient of motion corresponding to the Z-axis-only mode is less than zero, then this means the capsule endoscope is retreating backward through the passageway. If the coefficient of motion corresponding to the Z-axis-only mode equals zero, then the capsule endoscope neither advances nor retreats along the passageway.

Although a specific process for calculating optical flow values and image localization is described above, a number of processes may be utilized for calculating optical flow values in accordance with embodiments of the invention including feature based techniques that detect motion, where the frame rate of the capsule endoscope is sufficiently high to enable the tracking of features between frames. Such techniques can assume that locally the passageway is a rigid cylinder. For identified points in different frames, the only uncertainty is the movement of the capsule endoscope and/or the change in its orientation. When a sufficiently large number of points or features are located, the translation of the capsule endoscope between frames can be determined. Given appropriate calibration, the distances can be accumulated to create a spatial index of the captured frames of video. Methods for image localization and for determining motion and distance for capsule endoscopes in accordance with embodiments of the invention are described below.

### Post-Processing of Motion Data

In many embodiments, there are a large number of image sequences where no motion occurs, creating data redundancy in the video. These redundant frames can be identified and processed, for example by removing or combining all or part of the images, to create a spatially indexed series of captured images where each image represents progressive motion through a passageway. Post-processing can also be applied to remove outliers in the computed motion coefficients and to quantize small motion to zero. In some embodiments, clipping thresholds and scale adjustments can be introduced to set a bias toward forward motion. The data can be processed through a non-linear scaling function, one or more types of data clustering, and/or regression analysis for effective creation of spatially indexed data.

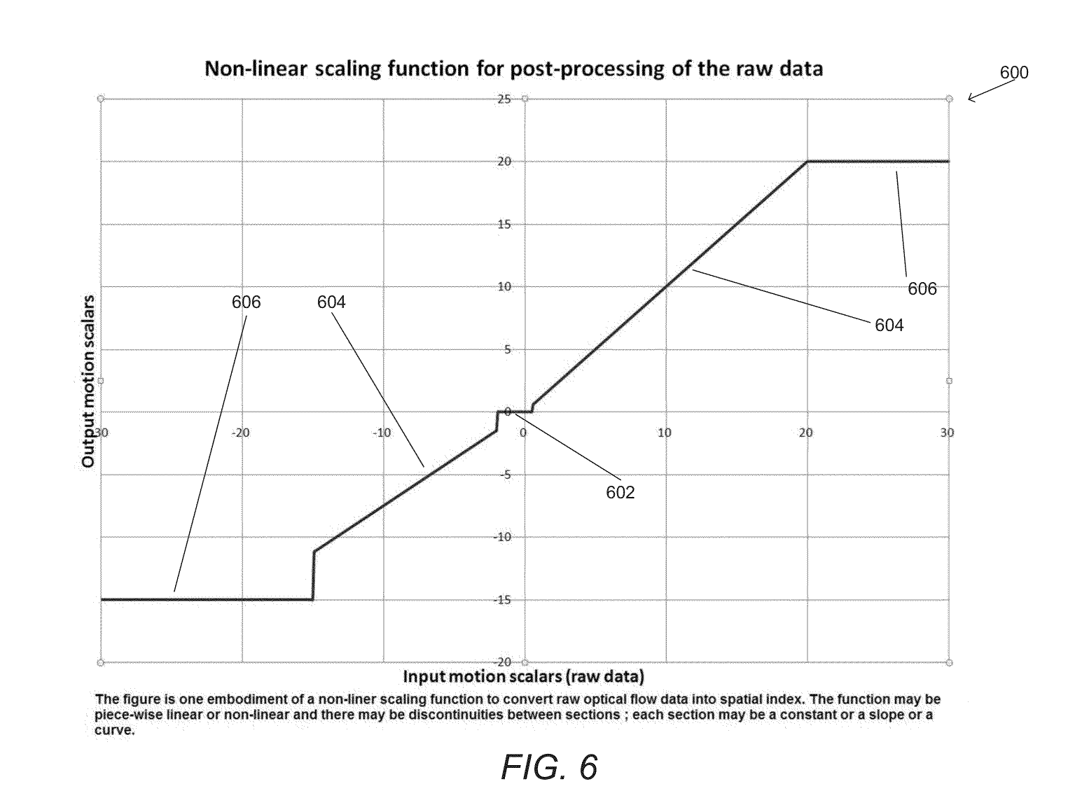

A non-linear scaling function for post processing of raw data in accordance with embodiments of the invention is illustrated in FIG. 6. The chart 600 illustrates a non-linear scaling function that maps an input motion scalar (raw data) to an output motion scalar. For very small motions (602) in either direction, the non-linear scaling function maps the input motion scalar to 0. Outside these clipping thresholds (which are slightly greater in the reverse direction), the non-linear scaling function is linear (604) and the input motion scalar is directly mapped to the output motion scalar. When the magnitude of the input motion scalar is sufficiently large in either direction (606) so as to indicate peristalsis (i.e. tissue motion instead of capsule motion), the non-linear scaling function maps the input motion scalar to a clipped value. In many embodiments, a bias scaling function biases the post-processed motion coefficients to produce a set of Z-axis translational motion coefficient that have a positive sum.

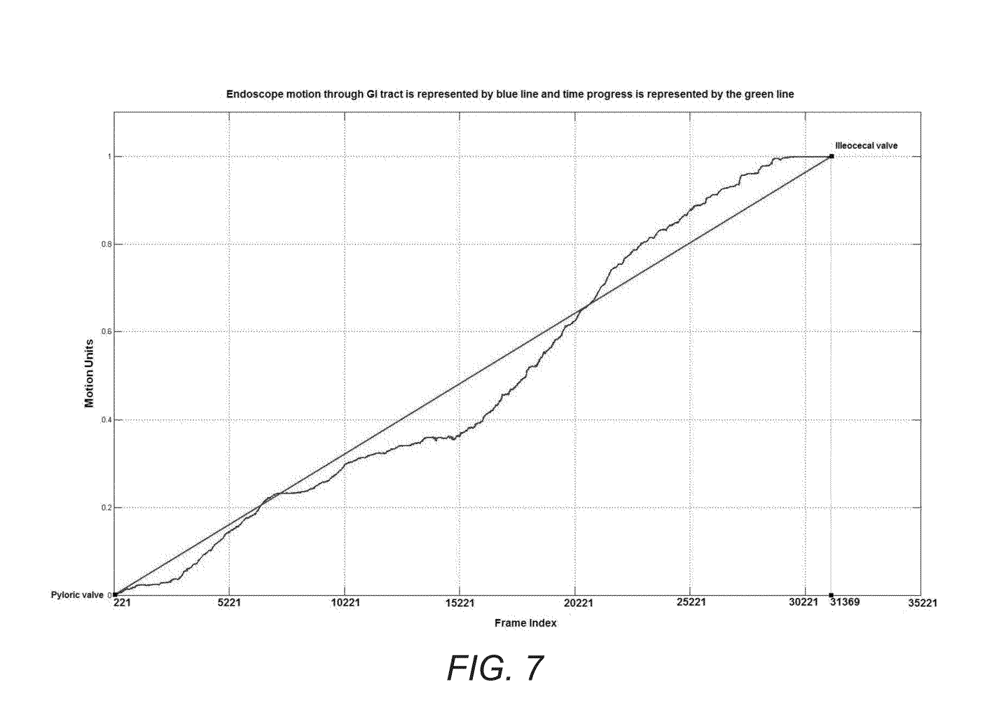

A chart illustrating capsule endoscope motion data through the entire small bowel of a patient that has been post-processed in accordance with an embodiment of the invention is illustrated in FIG. 7. Although a specific non-linear scaling function is illustrated in FIG. 6, any of a variety of scaling functions appropriate to a specific application (including images captured in other passageways) can be utilized in accordance with embodiments of the invention.

In embodiments where flipping of the capsule is detected, clipping coefficients can be reversed in response to detection of a flip. In embodiments in which an endoscope with more than one camera is utilized, such as a capsule with cameras 22 and 24 on each end as in FIG. 2, a spatial index can be calculated for each camera and given the known orientation and absolute distance between the cameras, the multiple spatial indices can be combined into a single spatial index with reduced noise, by combining them using techniques that can include weighted averaging or voting schemes or by assigning a distance offset to each frame corresponding to the location of the camera on the endoscope and calculating the spatial index from the entire set of frames from all cameras. The sum of the translation motion coefficients can be used to determine the distance between identifiable features of a passageway shown within the image sequence (e.g. the distance between the pyloric valve and the ileocecal valve in the GI tract). In other instances, any of a variety of post-processing steps can be applied to the motion data as appropriate to a specific application in accordance with embodiments of the invention.

### Detection of Motility of Walls of Passageway

Images taken during physiological activity, such as (but not limited to) peristaltic contractions, can indicate that the endoscopic camera has moved a great deal; however, after the contractions subside the camera may not have moved. Accordingly, it is useful to detect such physiological activity in order to minimize its effect during spatial indexing. In many embodiments, it may also be useful to measure the motility as a diagnostic tool.

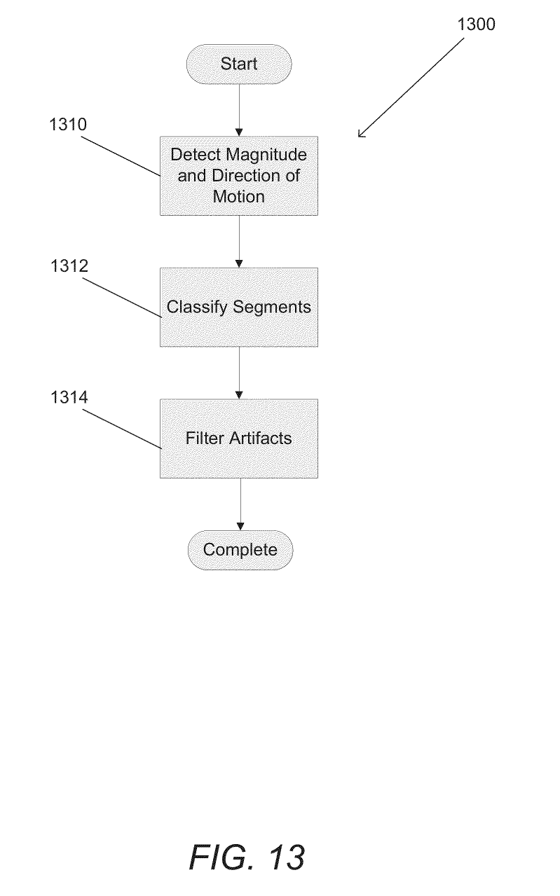

A process for detecting motility of the walls of passageway in accordance with an embodiment of the invention is illustrated in FIG. 13. The process 1300 involves detecting (1310) the magnitude and direction of motion of an endoscope, such as (hut not limited to) a capsule endoscope. In many embodiments, the magnitude and direction of the motion is detected (1310) using two or more images captured by the endoscope. Segments of an image series are classified (1312) to determine the type of motion detected (1310). Motion artifacts are filtered (1314) from the image series.

By detecting (1310) the magnitude and direction of motion that occurs between the set of two or more images, systems in accordance with embodiments of the invention can directly use the detected motion to classify (1312) segments of the image series that were captured during periods in which the walls of a passageway were moving in the field of view of the endoscope's camera (e.g. peristaltic contractions). During these periods when the passageway wall is contracting around the endoscope, a significant amount of rapid tissue distortion is introduced, which can create artifacts in the spatial index. These segments can be filtered (1314) out of the series during spatial indexing so that the estimation of motion of the endoscope recommences after the contractions have subsided and the motion has returned to quiescent motion. As is discussed further below, in many embodiments motility of the walls of the passageway is utilized as a diagnostic aid and sequences of images in which the motility of the wails is observed are used to generate such measurements,

Due to the large deformation inherent in peristaltic contractions, a translational model will likely diverge causing the system to infer that contraction or other deformation of the wails of the passageway is occurring. In a number of embodiments, the detection (1310) of motion in the wails of the passageway is performed using the motion vector. When a large motion is detected via the processing, either the endoscope has rapidly moved through the passageway (typically only occurs after a contraction of the passageway) or a contraction or other deformation of the walls of the passageway is grossly deforming the view of the passageway. Therefore, a classifier can be trained to differentiate between motion of the endoscope and motility of the walls of the passageway (e.g. motion associated with peristaltic contractions) when the motion vector exceeds a predetermined threshold.

Measuring and Visually Representing Motility Associated with Physiological Activity

In many embodiments, the detected motility of the walls of a passageway can be separately visually represented to provide information concerning the characteristics of contractions or other deformations associated with a subject's physiological activity. In many embodiments involving imaging of the GI tract, coefficients of motion vectors can also be utilized to generate a linear mapping of the peristaltic force with the capsule motion, which can in turn be used to identify any motility disorders. Very slow or rapid movement of the capsule immediately after a peristaltic contraction can be utilized in diagnosis of disorders including (but not limited to) dysmotility like irritable bowel syndrome and stenosis in the GI tract. Similar characteristics can be utilized in other contexts as a diagnostic aid.

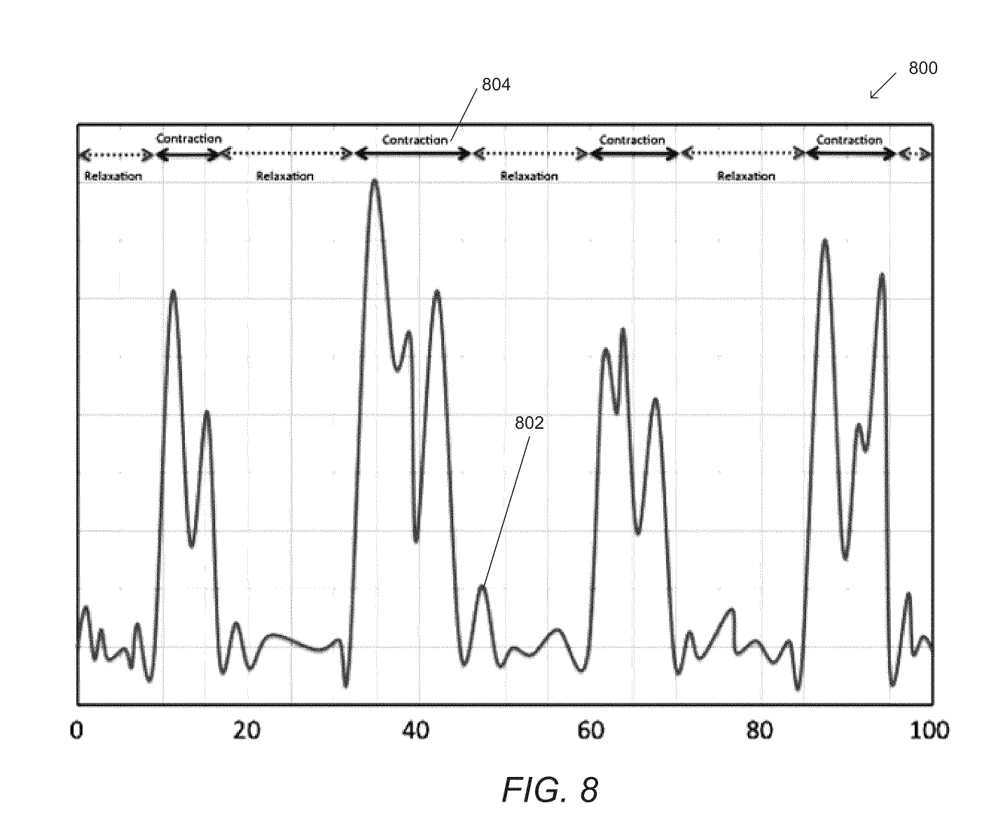

A conceptual representation of peristalsis in accordance with an embodiment of the invention is illustrated in FIG. 8. When measurements of peristaltic contractions are presented in a visual form, the visual representation of the measurements with respect to, but not limited to: time, frame count, and distance/spatial index, can be referred to as a Peristaltigram™. The schematic 800 exemplifies a plot of the detected intestinal motion 802 and indicates contractions 804 associated with normal peristalsis. A clinician can utilize the Peristaltigram as a diagnostic tool to assess normal motility and motility pathologies.

### Detecting Peristaltic Frames

Peristaltic frames (as is the case with many other types of motility) regularly present detectable patterns of motion vectors. During the contraction phase the motion vectors are initially predominantly radially inward and their magnitude increases exponentially towards the center of the lumen. The opposite occurs in the case of relaxation and expansion of the lumen. Also the temporal nature of the event of contraction followed by expansion helps in detecting the peristaltic frames, as it is absent in the case of forward or backward translational motion of the capsule. Forward and backward motion of the capsule in the quiescent tract also generates radially outward and inward motion vectors respectively but their magnitude varies linearly with the distance from the lumen center.

The detection accuracy of a peristalsis classifier in accordance with embodiments of the invention can be further augmented by identifying and utilizing characteristic image features of the peristaltic frames, such as the shrinking and growing areas of the open lumen and the edge orientation pattern, which are not observed in quiescent frames with only capsule motion. In addition, any of a variety of techniques for detecting peristaltic frames appropriate to a specific application can be utilized in accordance with embodiments of the invention.

### Determining Spatial Index for Each Frame

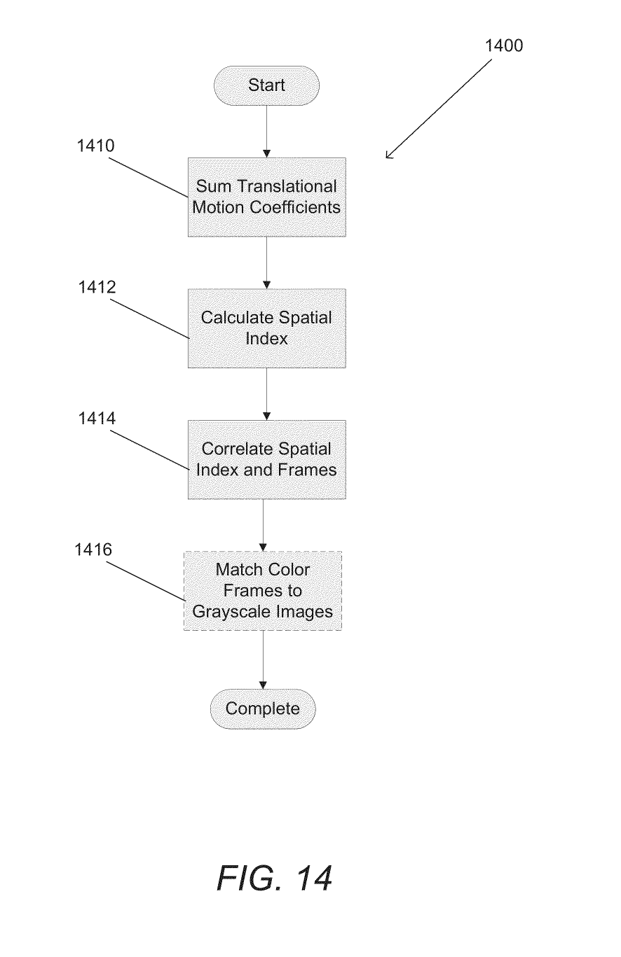

A spatial index in accordance with embodiments of the invention can represent either the relative distance traveled by the camera capsule or the absolute distance. The absolute distance can be determined when calibration is performed within a test setup that moves the endoscope a known distance and allows for measurement of the flow field produced. Calibration techniques which can be used in accordance with embodiments of the invention include, but are not limited to, utilizing the optical properties of the endoscope/camera system (focal length etc.) to calculate the size of known objects passing through the field of view of the endoscope such as anatomical structures or foreign bodies such as endoscopy clips placed during a previous procedure. A process for determining the spatial index for each frame in an image sequence in accordance with an embodiment of the invention is illustrated in FIG. 14. The process 1400 includes calculating (1410) the sum of the translational motion coefficients. The spatial index is calculated (1412). The spatial index is correlated (1414) with the frames.

In several embodiments, the spatial index is calculated (1412) from the Z-axis translational motion coefficients of the images by computing (1410) the sum of all motion coefficients corresponding to the Z-axis translational model for all the frames. For each frame, the cumulative sum of the Z-axis translational motion coefficients is determined (1410) and the spatial index is determined (1412) utilizing the ratio of the cumulative Z-axis translational coefficients and the sum of all Z-axis motion coefficients across the entire conditioned sequence. Once the spatial indexes of frames in the sequence have been determined (1412), the spatial indexes can be correlated (1414) to the corresponding images. In embodiments where grayscale images computed from color frames are used during spatial indexing, correlating (1414) the spatial index to the corresponding images includes matching (1416) the grayscale images to the original color frame. The spatially indexed image sequence can then be displayed via a display device such as a monitor or television screen to provide an attending physician with both an image sequence and an indication of the relative location of the images being viewed within the relevant passageway.

While the above description contains many specific embodiments of the invention, these should not be construed as limitations on the scope of the invention, but rather as an example of one embodiment thereof. For example, processes in accordance with embodiments of the invention can be utilized in flexible endoscopy and in the large intestine, esophagus and other organ systems. Accordingly, the scope of the invention should be determined not by the embodiments illustrated, but by the appended claims and their equivalents.

What is claimed is:

1. An endoscope system configured to generate a spatial index of images captured along a passageway, comprising:
a processor;
image storage; and
a camera configured to:
capture a plurality of images as the camera moves along a passageway; and
communicate the plurality of images to the processor; and
wherein the image storage is configured to store the plurality of images and the processor is configured to:
compare sets of at least two images from the plurality of images;
determine motion of the camera along the passageway using the sets of at least two images;
determine the distance the camera traveled along the passageway at the point at which an image in each of the sets of at least two images was captured; and
generate a spatial index for the plurality of images by associating distances traveled along the passageway with images in the plurality of images.

2. The system of claim 1, comprising:
a capsule endoscope that includes the camera; and
a computing system containing the processor and the image storage;
wherein the capsule endoscope is configured to transmit the captured plurality of images to the computing system.

3. The system of claim 1, further comprising a capsule endoscope including the processor, image store and camera.

4. The system of claim 1, wherein the processor being configured to compare sets of at least two images from the plurality of images comprises the processor being configured to detect motion selected from the group consisting of motion in a first axis along the passageway, motion in a second axis perpendicular to the first axis, motion in a third axis perpendicular to the first and second axes, and rotation about the first axis.

5. The system of claim 4, wherein:
the processor is configured to detect motion in a first axis along the passageway, motion in a second axis perpendicular to the first axis, motion in a third axis perpendicular to the first and second axes, and rotation about the first axis; and
the processor is configured to determine motion of the camera along the passageway utilizing the detected motion in the first, second, and third axes, and the detected rotation about the first axis.

6. The system of claim 5, wherein the processor being configured to determine motion along the passageway comprises the processor being configured to determine the location of a lumen in an image contained in the set of at least two images; and the processor is configured to detect motion in the first, second, and third axes, and the detected rotation about the first axis utilizing the location of the lumen in the image.

7. The system of claim 6, wherein the lumen is the darkest area of the image.

8. The system of claim 1, wherein the processor is further configured to perform post-processing of the determined motion along the gastrointestinal tract utilizing anon-linear scaling function.

9. The system of claim 8, wherein the non-linear scaling function maps determined motion below a predetermined threshold to zero.

10. The system of claim 8, wherein the non-linear scaling function maps the determined motion to a predetermined value when the determined motion exceeds the predetermined value.

11. The system of claim 1, further comprising at least one additional camera and the processor is configured to determine motion using images captured by multiple cameras.

12. The system of claim 1, the processor is further configured to measure motion of the walls of the passageway triggered by physiological contractions using the determined motion.

13. An endoscope system configured to measure motion in the walls of a passageway triggered by physiological contractions, comprising:
a processor;
a camera configured to:
capture a plurality of images as the camera moves along a passageway; and
communicate the plurality of images to the processor; and
wherein the processor is configured to:
compare sets of at least two images from the plurality of images;
detect motion of the walls of the passageway using the sets of at least two images; and
measure the motion of the walls of the passageway triggered by physiological contractions.

14. The system of claim 13, wherein the processor being configured to compare sets of at least two images from the plurality of images comprises the processor being configured to detect motion selected from the group consisting of motion in a first axis along the passageway, motion in a second axis perpendicular to the first axis, motion in a third axis perpendicular to the first and second axes, and rotation about the first axis.

15. The system of claim 14, wherein the processor is configured to detect motion in a first axis along the passageway, motion in a second axis perpendicular to the first axis, motion in a third axis perpendicular to the first and second axes, and rotation about the first axis.

16. The system of claim 13, wherein the processor being configured to compare sets of at least two images from the plurality of images comprises the processor being configured to determine the location of a lumen in an image contained in the set of at least two images.

17. The system of claim 16, wherein the passageway is a portion of the gastrointestinal tract and the processor is configured to:
detect motion radially toward a lumen during a peristaltic contraction; and
detect motion radially outward from the lumen during relaxation following a peristaltic contraction.

18. The system of claim 13, wherein the processor is configured to detect motion of the walls of the passageway using a classifier.

19. The system of claim 13, wherein the processor is configured to display the measurements of the motion of the walls of the passageway triggered by physiological contractions with respect to time or with respect to distance via a display device.

20. A method of generating a spatial index of images captured along a passageway, comprising:
comparing sets of at least two images from a plurality of images captured within a passageway using a processor;
determining motion of the camera along the passageway using the processor based on the sets of at least two images;
determining the distance traveled along the passageway at the point in the passageway at which an image in each of the sets of at least two images was captured, where the distance traveled is determined using the processor based on the determined motion; and
generating a spatial index for the plurality of images using the processor by associating distances traveled along the passageway with images in the plurality of images.

21. A method of measuring motion in the walls of a passageway triggered by physiological contractions, comprising:
comparing sets of at least two images from a plurality of images captured within a passageway using a processor;
detecting motion of the walls of the passageway using the processor based on the sets of at least two images; and
measuring of the motion of the walls of the passageway triggered by physiological contractions using the processor.

22. The method of claim 21, further comprising using the processor and a display device to display the measurements of the motion of the walls of the passageway with respect to time or with respect to distance.
